(19) United States
(12) Patent Application Publication
(10) Pub. No.: US 2025/0306226 A1
(43) Pub. Date: Oct. 2, 2025

(54) INTEGRATED MODELING FOR SEISMIC SURVEY ACQUISITION PARAMETERIZATION

(71) Applicant: Saudi Arabian Oil Company, Dhahran (SA)

(72) Inventors: Abdulrazaq Salamah, Dhahran (SA); Rudi Lubbe, Dhahran (SA)

(21) Appl. No.: 18/623,672

(22) Filed: Apr. 1, 2024

(51) Int. Cl. G01V 1/50

(52) U.S. Cl. CPC G01V 1/50; G01V 2210/1429; G01V 2210/161; G01V 2210/614; G01V 2210/6169; G01V 2210/6222

(57) ABSTRACT

A computer-implemented method includes: accessing wireline data and vertical seismic profiling (VSP) data; correlating logged velocity from the wireline data with velocity data from the VSP data to calibrate the logged velocity; determining, based on, at least in part, the calibrated logged velocity, a range of incidence angles for acquiring seismic traces sufficient to map a formation depth at the geo-exploration site using pairs of acoustic emitter and acoustic receiver placed at a surface of the geo-exploration site; and determining a range of offsets between the acoustic emitter and the acoustic receiver of each pair so that the acoustic receiver can acquire seismic traces sufficient to map the formation depth at the geo-exploration site; and comparing the range of angles and the range of offsets with acquisition parameters of a planned seismic survey to determine whether the planned seismic survey can map as deep as the formation depth.

### TECHNICAL FIELD

This disclosure generally relates to seismic surveys during which acoustic waves are launched to probe subterranean regions and the return echoes are acquired for analysis and image reconstruction of the subterranean regions.

### BACKGROUND

Field seismic data is often acquired during geophysical exploration in various industries, such as oil and gas, environmental studies, and civil engineering. The acquisition process generally involves deploying seismic sources and receivers in the field to measure the response of the subsurface to seismic waves from the seismic sources. Seismic data reconstruction generally involves the restoration of seismic signals or images to enhance the quality of data acquired from seismic surveys.

### SUMMARY

In one aspect, some implementations provide a computer-implemented method that includes: accessing wireline data and vertical seismic profiling (VSP) data, both encoding measurements taken from boreholes at a geo-exploration site; correlating velocity data log from the wireline data with velocity data from the VSP data to calibrate the velocity data log; responsive to results of said correlating meeting a pre-determined threshold, determining, based on, at least in part, the calibrated velocity data log, a range of incidence angles for acquiring seismic traces that reach a formation depth at the geo-exploration site using pairs of acoustic emitter and acoustic receiver placed at a surface of the geo-exploration site; subsequently determining a range of offsets between the acoustic emitter and the acoustic receiver of each pair so that the acoustic receiver can acquire seismic traces that reach the formation depth at the geo-exploration site; and comparing the range of angles and the range of offsets with acquisition parameters of a planned seismic survey to determine whether the planned seismic survey can sufficiently map the geo-exploration site.

Implementations may include one or more of the following features.

The computer-implemented method may further include: generating an alert that one or more of the acquisition parameters can cause the planned seismic survey to miss the formation depth at the geo-exploration site; and causing the acquisition parameters to be modified so that the planned seismic survey can sufficiently map the geo-exploration site. The computer-implemented method may further include: driving a rock physics model that operates on at least portions of the wireline data including the calibrated velocity data log to create synthetic gathers, wherein the rock physics model comprises a fluid substitution model instantiated at least twice to simulate a first instance of a first fluid condition at the geo-exploration site and a second instance for a second fluid condition at the geo-exploration site, and wherein the synthetic gathers include simulated seismic traces respectively for the first instance and the second instance. The range of incidence angles may range from a minimum incidence angle to a critical angle. The computer-implemented method may further include: generating, using an amplitude versus offset (AVO) model, responses to the synthetic gathers from the first instance and the second instance being launched from a surface of the geo-exploration site at various incidence angles; and determining the minimum incidence angle above which variations between respective responses are observed. The computer-implemented method may further include: generating, using an amplitude versus offset (AVO) model, responses to the synthetic gathers created in-situ from the wireline data at various incidence angles; and determining a critical incidence angle beyond which the modeled response is fully reflected. The computer-implemented method may further include: using a 1D ray tracing technique when determining the range of offsets. The 1D ray tracing technique may be performed within the range of angles and under the critical angle. The velocity data log may include: compressional velocity (Vp) data, and wherein the velocity data from the VSP data comprises checkshot velocity data. When the velocity data log is calibrated, the Vp data may be adjusted at depth points where the Vp data differs from the checkshot velocity data.

In another aspect, some implementations provide a computer system comprising one or more hardware computer processors configured to perform operations of: accessing wireline data and vertical seismic profiling (VSP) data, both encoding measurements taken from boreholes at a geo-exploration site; correlating velocity data log from the wireline data with velocity data from the VSP data to calibrate the velocity data log; responsive to results of said correlating meeting a pre-determined threshold, determining, based on, at least in part, the calibrated velocity data log, a range of incidence angles for acquiring seismic traces that reach a formation depth at the geo-exploration site using pairs of acoustic emitter and acoustic receiver placed at a surface of the geo-exploration site; subsequently determining a range of offsets between the acoustic emitter and the acoustic receiver of each pair so that the acoustic receiver can acquire seismic traces that reach the formation depth at the geo-exploration site; and comparing the range of angles and the range of offsets with acquisition parameters of a planned seismic survey to determine whether the planned seismic survey can sufficiently map the geo-exploration site as deep as the formation depth.

Implementations may include one or more of the following features.

The computer-implemented method may further include: generating an alert that one or more of the acquisition parameters can cause the planned seismic survey to miss the formation depth at the geo-exploration site; and causing the acquisition parameters to be modified so that the planned seismic survey can sufficiently map the geo-exploration site. The computer-implemented method may further include: driving a rock physics model that operates on at least portions of the wireline data including the calibrated velocity data log to create synthetic gathers, wherein the rock physics model comprises a fluid substitution model instantiated at least twice to simulate a first instance of a first fluid condition at the geo-exploration site and a second instance for a second fluid condition at the geo-exploration site, and wherein the synthetic gathers include simulated seismic traces respectively for the first instance and the second instance. The range of incidence angles may range from a minimum incidence angle to a critical angle. The computer-implemented method may further include: generating, using an amplitude versus offset (AVO) model, responses to the synthetic gathers from the first instance and the second instance being launched from a surface of the geo-exploration site at various incidence angles; and determining the minimum incidence angle above which variations between respective responses are observed. The computer-implemented method may further include: generating, using an amplitude versus offset (AVO) model, responses to the synthetic gathers created in-situ from the wireline data at various incidence angles; and determining a critical incidence angle beyond which the modeled response is fully reflected. The computer-implemented method may further include: using a 1D ray tracing technique when determining the range of offsets. The 1D ray tracing technique may be performed within the range of angles and under the critical angle. The velocity data log may include: compressional velocity (Vp) data, and wherein the velocity data from the VSP data comprises checkshot velocity data. When the velocity data log is calibrated, the Vp data may be adjusted at depth points where the Vp data differs from the checkshot velocity data.

Implementations according to the present disclosure may be realized in computer implemented methods, hardware computing systems, and tangible computer readable media. For example, a system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The details of one or more implementations of the subject matter of this specification are set forth in the description, the claims, and the accompanying drawings. Other features, aspects, and advantages of the subject matter will become apparent from the description, the claims, and the accompanying drawings.

### DESCRIPTION OF DRAWINGS

FIG. 1A depicts an example of a flowchart according to some implementations of the present disclosure.

FIG. 1B shows an example of a seismic surveying system according to some implementations of the present disclosure.

FIG. 2A shows an example of a seismic acquisition system according to some implementations of the present disclosure.

FIG. 2B shows additional details of the seismic acquisition system of FIG. 2A.

FIGS. 3A to 3C show an example of a workflow diagram according to some implementations of the present disclosure.

FIG. 4 illustrates an example of a diagram for calculating offsets as used in some implementations of the present disclosure.

FIGS. 5A to 5D show an example of integrating seismic data, vertical seismic profiling (VSP) data, rock physics fluid substitution modeling and amplitude versus offset (AVO) modelling according to some implementations of the present disclosure.

FIG. 6 illustrate another example of a flow chart according to some implementations of the present disclosure.

FIG. 7 shows an example of flow chart for performing finite difference modeling according to some implementations of the present disclosure.

FIG. 8 is another block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

A seismic survey is often performed at a geo-exploration site to investigate the oil and gas potentials for underground formation layers at the geo-exploration site. Because the geophysical variations of underground formations, it is technically challenging to place acoustic emitters and receivers in the vast area of the geo-exploration site to sufficiently cover all depth of interest.

The disclosure is directed to system and method for seismic acquisition design to provide adequate seismic illumination at the reservoir for lithology/fluid discrimination. The implementations integrate seismic data, vertical seismic profiling (VSP) data, rock physics fluid substitution modeling and amplitude versus offset (AVO) modeling to evaluate seismic acquisition parameters suitable for a particular site under investigation to ensure the seismic survey would sufficiently map the deepest geological formation.

Specifically, some implementations correlate fluid substitution modeling and VSP data logging. Utilizing the log data (i.e., wireline data), acquired in one or more wells, the implementations employ 1D ray tracing to model (e.g., predict) the seismic acquisition offset needed to image the reservoir at depth. The implementations allow for the prediction of the minimum offset needed to characterize the fluid saturation in the reservoir by means of rock physics guided pre-stack inversion. The implementations also provide additional read-out such as the minimum angle (required to view the lithology and/or fluid effect) as well as the maximum (i.e., critical) angle. Some implementations perform quality control of input data by, for example, calibrating log data (e.g., wireline data) with seismic/VSP data, so that rock physics analysis results can be plugged into AVO analysis to evaluate the parameters through 1D ray tracing modeling.

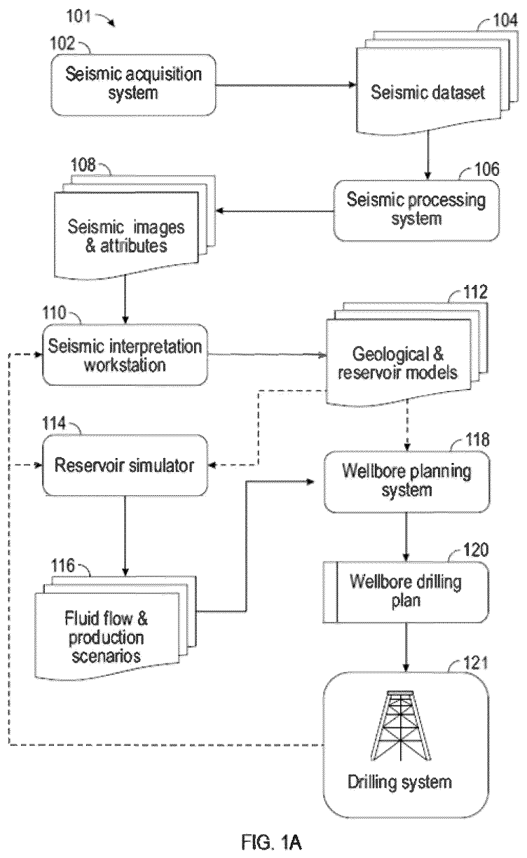

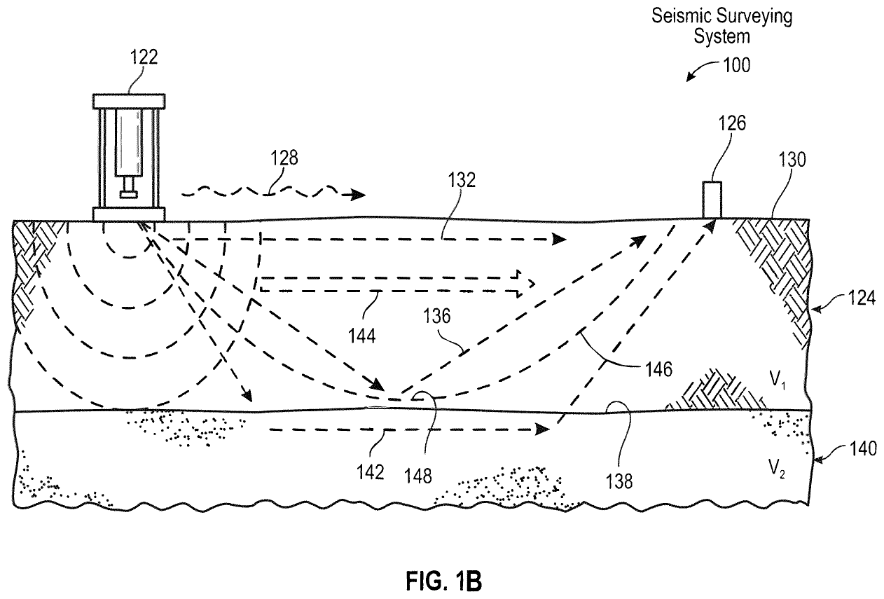

The subject matter described in this specification can be implemented to realize one or more of the following advantages. First, some implementations can improve the seismic acquisition design to provide adequate seismic illumination at the reservoir for lithology/fluid discrimination so that the planned seismic survey, once completed, can provide a fulsome coverage of the intended formation depths and subsequent seismic reconstruction can map the reservoir as far as the intended layers. Second, some implementations can integrate wireline data and vertical stack profiling (VSP) data from existing boreholes at the geo-exploration site and apply rock physics fluid substitution modeling and arrival-versus-offset (AVO) modeling to provide a more robust software module to generate more accurate prediction (e.g., minimum incidence angle, critical angle, and range of offsets), based on existing data, for guiding seismic surveys. The software module thus significantly extends the capabilities of computerized tools. Third, the implementations handle voluminous amount of data that is impractical for the human mind. For example, the datasets are extremely large, typically occupying hundreds of Terabytes or more than a Petabyte in size, (corresponding to between 10 trillion (10¹³) and 100 trillion (10¹⁴) data samples) and cannot be manipulated or “processed” without the assistance of a purpose configured seismic processing system. Details of the implementations are provided below in association with FIGS. 1A-1B, 2A-2B, 3A-3C, 4, 5A-5D, 6-8.

### Glossary of Terms

Wireline Data, in the context of geophysics and subsurface exploration, refers to measurements and information collected using a wireline tool, which is a specialized instrument attached to a cable or wireline. Wireline data is often collected through a process called borehole logging, during which the wireline tool is lowered or raised through the borehole, and measurements are taken at various depths. Wireline tools can be equipped with a variety of sensors and instruments to measure different properties of the subsurface. Common measurements include: caliper log, gamma ray, neutron porosity, total porosity, total saturation, resistivity, compressional wave velocity log (Vp), shear wave velocity log (Vs), and directional data (well inclination and azimuth). Here, Vp and Vs are logged by means of wireline monopole sonic measurement tools. In some wireline logging operations, data can be transmitted in real-time to the surface, allowing for immediate analysis and decision-making.

Vertical Seismic Profiling (VSP) Data, in the context of geophysics and subsurface exploration, refers to measurements and information collected from a VSP operation, which involves deploying seismic sensors (geophones or accelerometers) in a borehole and using a seismic source at the surface or another location to generate seismic waves. The seismic sensors in the borehole record the arrival times and amplitudes of these waves. Unlike traditional surface seismic surveys where sources and receivers are located at the surface, VSP involves placing seismic sensors (geophones or accelerometers) in a borehole as well as deploying a seismic source at the surface or another location. VSP can refer to a common offset VSP, or a walkway VSP. In common offset VSP, the seismic source and borehole sensors are located at different lateral distances (offsets) from the borehole. This type of VSP provides information about the subsurface away from the borehole axis. In walkway VSP, the seismic source is moved to different locations at the surface, and the borehole sensors record the seismic response. The walkaway VSP helps create a 3D image of the subsurface around the borehole. VSP data can be instrumental for characterizing the properties of reservoirs, including fluid content, porosity, and permeability, as well as for detecting fractures and other small-scale features in the subsurface. VSP data can further facilitate imaging the geological formations in the vicinity of the wellbore, thereby aiding well planning and drilling operations.

A checkshot survey is a specific type of well log conducted in a borehole to measure the travel times of seismic waves between a seismic source and receivers in a borehole at different depths. A borehole is drilled, and geophones or accelerometers are positioned at known depths within the borehole. A seismic source, which could be at the surface or at a separate location, generates seismic waves that travel through the subsurface and are recorded by the sensors in the borehole. Checkshot surveys can be conducted independently of VSP, but they are often associated with VSP surveys, especially in the context of calibrating seismic data for wellbore imaging. In VSP surveys with common offsets, checkshot data are often collected at the same time. Common offset VSP involves placing the seismic source at different lateral distances from the borehole while collecting both VSP and checkshot data. This provides additional information about subsurface structures away from the wellbore. VSP checkshot velocity is measured from borehole seismic receivers detecting acoustic waves from a seismic source on the surface.

A Fluid Substitution Model is a rock physics based method to estimate the elastic response (Vp, Vs, Density logs) across a borehole by predicting the elastic response based on the fluids present in the porosity at each depth point. In more general terms, the fluid substitution model can predict the seismic response of subsurface formations when the fluid content changes during the analysis of seismic data for hydrocarbon reservoirs. Because different fluids (such as water, oil, and gas) have different acoustic properties, the presence of different fluids in a reservoir can significantly affect the seismic response. Different fluids have distinct acoustic properties, including compressional (P-wave) and shear (S-wave) velocities. For example, the P-wave velocity of water is typically higher than that of oil, and the P-wave velocity of oil is higher than that of gas. Fluid substitution models thus facilitate how changes in fluid content within the reservoir can impact seismic amplitudes, velocities, and other seismic attributes. Rock physics models are employed in fluid substitution to link the elastic properties of rocks with fluid content. These models take into account factors such as porosity, mineralogy, and fluid type while using Gassmann's equations for predicting the changes in elastic properties (such as bulk modulus and shear modulus) when one fluid is replaced by another in a porous rock. Fluid substitution models can particularly help predict changes in seismic attributes, including reflection coefficients, amplitude versus offset (AVO) responses, and seismic velocities, as a function of fluid content.

AVO, or Amplitude-Versus-Offset, refers to a seismic phenomenon where the amplitude of seismic reflections changes with the offset (the lateral distance between the source and receiver) of the seismic survey. AVO is based on the principle that the amplitude of seismic reflections is influenced by the angle of incidence of the seismic waves and the properties of the subsurface rocks, particularly the presence of fluids. AVO analysis can be particularly sensitive to changes in fluid content within subsurface formations. Gas-filled reservoirs often exhibit distinct AVO responses. AVO responses can also provide information about lithology and rock properties. Shale content and the presence of sandstone versus limestone can affect AVO behavior. AVO response can thus reveal information about the subsurface properties, especially the presence of fluids in geological formation.

A Geological (Static) Model is a geological model that can be built using all static data (including geology, geophysics, petrophysical, fluid contacts, and core data) that provide characteristics of reservoir properties. The geological model also includes drilled wells with their trajectories. The geological model is the first step in modeling any field, and is usually built for the full field before being converted to a full-field dynamic simulation model. The geological model usually does not include dynamic data.

In seismic data processing, a corridor stack refers to a type of seismic stack that is created by stacking traces within a narrow corridor or window along the shot and receiver lines. The corridor stack is a summation of seismic traces that fall within this specified corridor. Corridor stack can be used in 3D seismic data processing to enhance the signal-to-noise ratio and improve the imaging of subsurface structures. In other words, the corridor stack can be used to enhance the visibility of subsurface features by emphasizing coherent events and suppressing random noise. The width of the corridor is chosen based on the geological characteristics of the subsurface and the expected size of the target features.

Synthetic gathers refer to synthetic seismic traces generated using a mathematical model of the subsurface. These traces simulate the response of the subsurface to seismic waves. Synthetic gathers can be used for calibration, quality control, and testing in seismic data processing by providing a reference for comparing and validating the results obtained from real seismic data. Synthetic gathers can be generated by convolving a seismic wavelet (such as, e.g., a Ricker wavelet) with a subsurface model. The model includes information about the geological layers, velocities, and other relevant parameters.

A Common Midpoint (CMP) stack refers to a stacking technique that involves stacking traces with a common midpoint between acoustic emitters and acoustic receivers. In seismic data processing, CMP can be used to improve signal quality and generate subsurface images when traces with a common midpoint are stacked to enhance coherent signals and attenuate random noise.

An offset gather is a collection of seismic traces with a common midpoint but varying offsets. The offset gather can provide information about the seismic response at different source-receiver offsets. Offset gathers are often used in the analysis of amplitude variations with offset (AVO) and other studies related to the distribution of subsurface reflectivity. Seismic data is gathered at various offsets for a specific midpoint, allowing the examination of how the seismic response changes with different source-receiver distances.

Core Data can include core samples taken out of actual reservoir formations under in-situ conditions during drilling phase of the wells, which can provide valuable data on reservoirs and fluids. Core data may only be collected in a few wells depending upon the objectives. Core data samples can be transferred to a laboratory for detailed analyses. When available, core data can provide more reliable reservoir fluid properties than petrophysical log data. In some cases, core data can be used to adjust or calibrate log data. This may be done because core data can be considered more reliable than the log data. In cases in which core data is not available, techniques can rely on petrophysical log data. If core data in offset wells is available, then the core data can also be used for enhancing reservoir descriptions.

Geology and Geophysics Data can be collected from the field seismic survey. Collected seismic field data can be input into the workflow where the data can be analyzed and interpreted to derive geological structures, rock typing, and reservoir features (including fractures, faults, and unconformity) of the reservoir. As the seismic data has the capability of capturing only large features in the field or the reservoir, localized geological features may be missed, such as fractures, faults, and unconformity. Based on the shape of the reservoirs, structural maps (for example, contour maps) can be generated by using depth scales. By using contour maps along with seismic interpretation, rock typing can be determined. Reservoir structures as interpreted from seismic data can be incorporated in numerical models if structural contour maps are available from seismic data.

An Operational Platform can serve as a computer-aided enabler in performing specific operations on a sector model that is regarded as an operational platform. Such a platform can execute requests for visualization of, and computational operations on, uploaded models. The operational platform can also display input parameters and field data, compute model outputs, and compare model outputs to field data. The operational platform can also have the capability of simplifying well trajectories, production data, and injection data to reduce the computational burden. Manipulation of grids, including upscaling and refining as needed, can also be performed on sector models.

Petrophysics can refer to reservoir properties (for example, permeability, porosity, saturations, and pay thickness) originating from petrophysical log data to build static geological models. Petrophysical logs can be built during the drilling phase of the well. Logging tools can be run in-hole. Wellbore, rock, and fluid information can be collected, which can later be processed and analyzed to estimate detailed reservoir properties such as permeability, porosity, saturations, and thickness. Petrophysical logs can provide the resolution needed to pick up localized features in the well or in the vicinity of the well. Logs can be the primary sources of most important and reliable data, providing a detailed description of the rock, fluid, and well. This information can be input to static geological models. In case a given subject well does not have petrophysical information, modelers can turn to other offset wells for petrophysical data for building the models.

FIG. 1A depicts a flowchart (101) in accordance with some implementations of the present disclosure. FIG. 1A illustrates the steps of acquiring remote sensing data, processing the remote sensing data, forming a geological model, optionally simulating the flow of fluids, including hydrocarbons, though the geological model, the planning of wellbores including their surface position, trajectories, and targets, and the drilling of those wellbores. Although the steps in flowchart (101) are shown in sequential order, it will be apparent to one of ordinary skill in the art, that some steps may be conducted in parallel, or in a different order than shown, or may be omitted without departing form the scope of the subject matter.

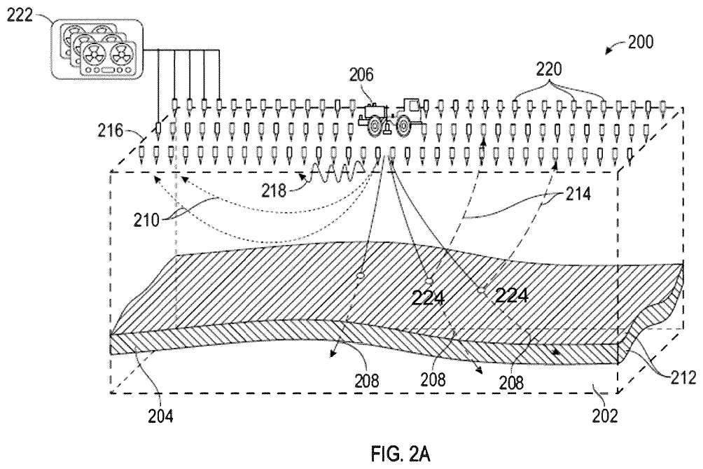

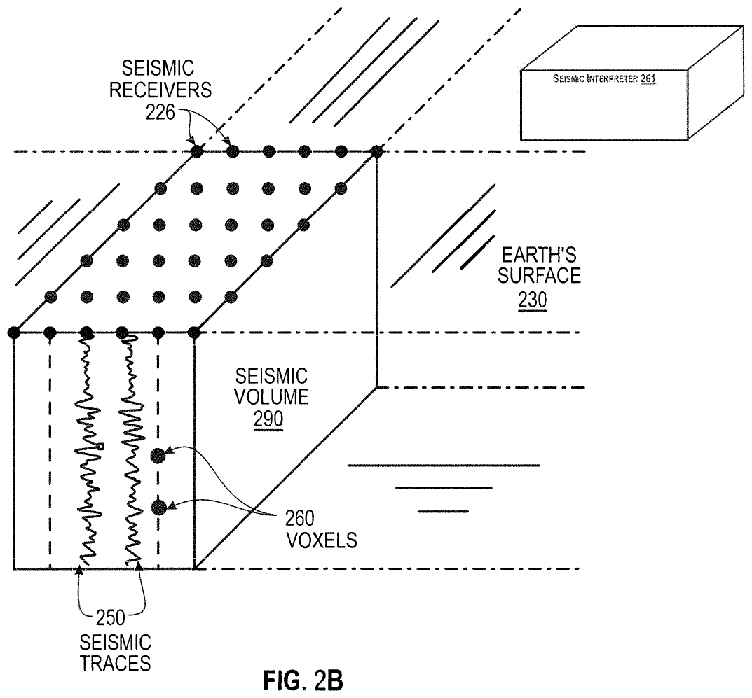

For example, flowchart (101) may begin with the use of a seismic acquisition system (102) to acquire a seismic dataset (104) over a subterranean region of interest. The seismic acquisition system (102) will be described in more detail in the context of FIGS. 2A and 2B, and part of the seismic surveying system 100 of FIG. 1B. Other remote sensing datasets may also be collected at this stage to characterize the subterranean region of interest. For example, resistivity, transient electromagnetic, and/or gravitation surveys may be collected.

The seismic dataset contains seismic recordings that are influenced by the geological structure of the subterranean region. However, seismic datasets (104) also contain a wide variety of noise and distortion and does not in its unprocessed “raw” form display significant useful information about the subterranean region. Consequently, seismic datasets (104) are typically processed to remove or attenuate noise and to correctly locate geological boundaries that reflect seismic waves (“seismic reflectors” in two-dimensional (“2D”) or three-dimensional (“3D”) space within the subterranean region.

To determine earth structure, including the presence of hydrocarbons, the seismic data set must be processed. Processing a seismic dataset includes a sequence of steps designed to correct for near-surface effects, attenuate noise, compensate for irregularities in the seismic survey geometry, calculate a seismic velocity model, image reflectors in the subterranean and calculate a plurality of seismic attributes to characterize the subterranean region of interest to determine a drilling target. Each of these steps may be accompanied by one or more quality control steps. Critical steps in processing seismic data include beam forming and seismic migration. Seismic migration is a process by which seismic events are re-located in either space or time to their true subsurface positions.

It will be appreciated by one of ordinary skill in the art that seismic datasets (104) are extremely large, typically occupying hundreds of Terabytes or more than a Petabyte in size, (corresponding to between 10 trillion (10¹³) and 100 trillion (10¹⁴) data samples) and cannot be manipulated or “processed” without the assistance of a purpose configured seismic processing system (106).

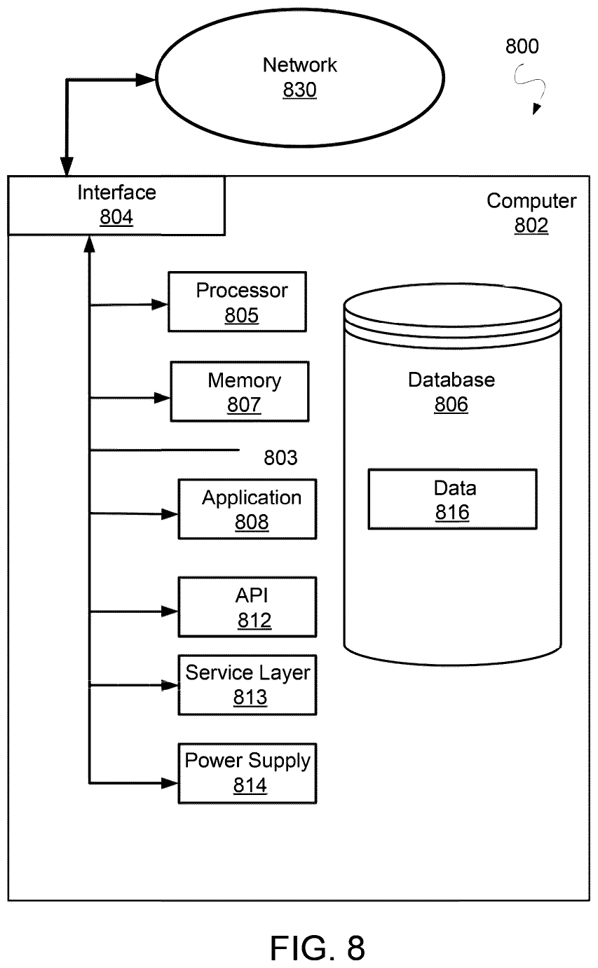

A seismic processing system (106) may be composed of a computer system, such as the computer system shown in FIG. 8. However, a seismic processing system will typically be configured with appropriate seismic processing software and augmented with a number of purpose specific elements, such as high capacity tape drives or hard drives connected through high-speed buses to computer processing units (“CPUs”). Further the CPUs of a seismic processing system will typically be connected to a plurality of graphical processing units (“GPUs”) that perform many of the computationally intensive operations on the seismic dataset (104), banks of high-speed tape, or hard-drive, readers to read the data from storage, high-speed tape or hard-drive writers to output final or intermediate results, and high-speed communication buses to connect these elements.

The result of processing a seismic dataset (104) with a seismic processing system (106) is a seismic image (108). The seismic image is a 2D or 3D image of the points within the subsurface that generate a distinctive seismic response. For example, the seismic image (108) may display the points at which seismic energy is reflected, or scattered, within the subsurface. Other seismic characteristic or “attributes” of the subsurface may be displayed as a seismic image (108). For example, the strength of conversion of energy from one type of seismic wave to another, or the strength of absorption of seismic energy, or the velocity of seismic propagation may be displayed as a function of subsurface position in the seismic image (108). The examples of seismic attributes given above are purely illustrative, and a person of ordinary skill in the art will appreciate that anyone of dozens of other attributes may be displayed as a seismic image (108) and the examples described should not be interpreted as limiting the scope of the inventive subject matter.

The seismic image (108) is an image, typically composed of pixels of varying intensity, and is not itself a model of the geological structure of the subterranean region to which it pertains. To determine the geological structure corresponding to, or that produced, the seismic image (108) the seismic image (108) is typically “interpreted” using a seismic interpretation workstation (110).

A seismic interpretation system (110) is primarily used by geoscientists, seismic interpreters, and exploration teams in the oil and gas industry for analyzing seismic data to understand subsurface geological structures. Seismic interpreters use the workstation to visualize seismic data, including 2D and 3D seismic volumes, cross-sections, time slices, and attribute maps. These visualizations provide insights into subsurface structures, faults, and potential hydrocarbon reservoirs. Additional data may be used within the seismic interpretation workstation (110) to facilitate the interpretation of the seismic dataset, Such additional data may include well logs acquired from previously drilled wells and acquired either while-drilling or via wireline conveyed well logging tools after drilling. Such data may also include non-seismic remote sensing datasets such as resistivity, transient electromagnetic, and/or gravitational surveys.

Interpreters may pick and interpret key geological horizons within seismic data to identify stratigraphic layers, boundaries, and structural features. Horizon interpretation tools and workflows allow for the accurate extraction of geological information from seismic volumes. For example, a seismic interpretation system (110) enables interpreters to identify and interpret subsurface faults that may impact hydrocarbon reservoirs. Fault interpretation tools and visualization techniques help in understanding fault geometry, connectivity, and spatial relationships. Seismic attributes, such as amplitude, frequency, and gradient, provide additional information about subsurface properties and can be analyzed using various algorithms and statistical methods. Attribute analysis tools in the workstation aid in defining reservoir characteristics, identifying anomalies, and highlighting potential hydrocarbon traps.

Interpreters may use the seismic interpretation system (110) to build 3D geological models by integrating seismic data with well-log data, geological knowledge, and other geophysical information. These models help in estimating reservoir properties, optimizing well locations, and predicting hydrocarbon distribution. Interpreters may analyze and characterize hydrocarbon reservoirs by integrating different data sources, including seismic data, well logs, production data, and seismic inversion results. Workstations provide tools for reservoir property estimation, quantitative analysis, and reservoir performance evaluation.

The seismic interpretation system (110) may facilitate prospect generation and evaluation, where interpreters identify and assess areas with high hydrocarbon exploration potential. They can perform detailed geological and geophysical analysis, identify drilling targets, and quantify the risk and uncertainty associated with potential prospects. Finally, workstations enable interpreters to collaborate with team members, share interpretation results, and communicate findings effectively. Interpretation software allows for the creation of reports, annotated images, and presentations to communicate geological interpretations to stakeholders.

The seismic interpretation system (110) can be instrumental for geoscientists involved in exploration and production activities, helping them make informed decisions about drilling locations, optimize production strategies, and understand complex subsurface geological structures. The seismic interpretation system (110) may be a specialized computer system used by geoscientists and seismic interpreters for analyzing and interpreting seismic data.

Seismic interpretation involves intensive tasks like data visualization, horizon picking, attribute analysis, and 3D modeling. A high-performance seismic interpretation system (110) with a powerful processor, ample memory, and a high-resolution display is essential to handle these computationally demanding tasks efficiently. Dedicated GPUs may be crucial for real-time rendering of seismic data, enabling smooth and interactive visualization. GPUs with high memory and parallel processing capabilities accelerate tasks like volume rendering and horizon visualization.

Seismic interpretation often involves working with large and complex datasets. Multiple high-resolution monitors allow interpreters to view seismic data, cross-sections, time slices, attribute maps, and other visualizations simultaneously, enhancing productivity and analysis accuracy. The seismic interpretation system (110) may be equipped with industry-standard software applications tailored for seismic interpretation, such as seismic data processing and visualization tools, horizon and fault interpretation systems, attribute analysis software, and 3D modeling software.

Seismic interpretation projects generate substantial amounts of data, including seismic volumes, processed data, interpretation results, and velocity models. A high-capacity and fast storage system, such as solid-state drives (SSDs) or RAID arrays, is necessary to store and access this data efficiently. The seismic interpretation system (110) often requires network connectivity to access centralized data repositories, collaborate with colleagues, and share interpretation results. A robust network infrastructure with fast Ethernet or fiber connections ensures smooth data transfer and collaboration capabilities.

Essential peripherals like keyboards, mice, and graphics tablets enable efficient interaction with data and software interfaces. A seismic interpretation workstation (110) may be augmented with purpose specific peripherals such as high capability display devices that may include immersive or virtual reality devices, such as virtual-reality headsets or immersive “caves”. Additionally, color-calibrated and high-accuracy input devices enhance the precision of interpretation tasks like picking horizons or drawing geological features. The seismic interpretation system (110) should have backup solutions in place to protect valuable data from loss or damage. Automated backup systems, external storage devices, or network-attached storage (NAS) can be utilized to ensure data safety. In some cases, seismic interpreters may need remote access to the seismic interpretation system (110) or collaborate with colleagues remotely. Setting up remote access capabilities, such as Virtual Private Networks (VPNs) or remote desktop solutions, allows interpreters to work from different locations and share their work effectively. The seismic interpretation system (110) may be customized to meet the needs of interpreters and the specific requirements of projects. The hardware specifications may vary based on factors like the complexity of interpretations, the size of datasets, and the software tools utilized.

The result of interpreting the seismic image may be a geological model (112) of the subsurface, including reservoir models of hydrocarbon reservoirs within the subterranean region of interest. Geological models (112) may include the locations of geological interfaces, such as the boundary between volumes (“formations”) containing different rock types (“facies”), and faults and fractures. Geological models may also include descriptions of the characteristics of the different facies including characteristics such as porosity and permeability, and the relative amounts of different fluids, such as gas, oil and brine, within the pores in each facies.

In some embodiments, the geological models (112) may be used directly to create a wellbore drilling plan (120) using a wellbore planning system (118). Such a wellbore drilling plan (120) may contain drilling targets, often geological regions expected to contain hydrocarbons. The wellbore planning system (118) may plan wellbore trajectories to reach the drilling targets while simultaneously avoiding drilling hazard, such as preexisting wellbores, shallow gas pockets, and fault zones, and not exceeding the constraints, such as torque, drag and wellbore curvature, of the drilling system (122). Similarly, the wellbore drilling plan (120) may include a determination of wellbore caliper, and casing points.

The wellbore planning system (118) may include dedicated software stored on a memory of a computer system, such as the computer system shown in FIG. 8. The wellbore plan (120) may be informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes.

The wellbore path may include a starting surface location of the wellbore, or a subsurface location within an existing wellbore, from which the wellbore may be drilled. The wellbore path may further include a terminal location that may intersect with the previously located hydrocarbon reservoir, such as hydrocarbon reservoir (204) shown in FIG. 2A. The wellbore path may further still include wellbore geometry information such as wellbore diameter and inclination angle and when each of these change along the depth of the wellbore. If casing is used, the wellbore plan (120) may include casing type or casing depths. Furthermore, the wellbore plan (120) may consider other engineering constraints such as the maximum wellbore curvature (“dog-log”) that a drill string of a drilling system may tolerate and the maximum torque and drag values that the drilling system may provide. The wellbore plan (120) may further define associated drilling parameters, such as the planned depths at which drilling may be paused and casing will be inserted to support the wellbore to prevent formation fluids entering the wellbore and the drilling mud weights (densities) and types that may be used during drilling of the wellbore.

In some implementations, the geological model (112) may be input to a reservoir simulator (114). A reservoir simulator (114) includes functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator (114) may be used to predict changes in fluid flow, including fluid flow into wells penetrating the reservoir as a result of planned well drilling, and/or fluid injection and extraction. For example, the reservoir simulator may be used to predict fluid-flow and production scenarios (116) including changes in hydrocarbon production rate that would result from the injection of water into the reservoir from wells around the reservoirs periphery.

The reservoir simulator (114) may use a geological model or reservoir model (112) that contains a digital description of the physical properties of the rocks as a function of position within the reservoir and the fluids within the pores of the porous, permeable reservoir rocks at a given time. In some embodiments, the digital description may be in the form of a dense 3D grid with the physical properties of the rocks and fluids defined at each node. In some embodiments, the 3D grid may be a cartesian grid, while in other embodiments the grid may be an irregular grid.

The physical properties of the rocks and fluids within the reservoir may be obtained from a variety of geological and geophysical sources. For example, remote sensing geophysical surveys, such as seismic surveys, gravity surveys, and active and passive source resistivity surveys, may be employed. In addition, data collected from well logs acquired in well penetrating the reservoir may be used to determine physical and petrophysical properties along the segment of the well trajectory traversing the reservoir. For example, porosity, permeability, density, seismic velocity, and resistivity may be measured along these segments of wellbore. In accordance with some embodiments, remote sensing geophysical surveys and physical and petrophysical properties determined from well logs may be combined to estimate physical and petrophysical properties for the entire reservoir simulation model grid.

Reservoir simulators can solve a set of mathematical governing equations that represent the physical laws that govern fluid flow in porous, permeable media. For example, the flow of a single-phase slightly compressible oil with a constant viscosity and compressibility pursuant to Darcy's law, the continuity condition and the state equation.

Additional, and more complicated equations are required when more than one fluid, or more than one phase, e.g., liquid and gas, are present in the reservoir. Further, when the physical and petrophysical properties of the rocks and fluids vary as a function of position the governing equations may not be solved analytically and must instead be discretized into a grid of cells or blocks. The governing equations must then be solved by one of a variety of numerical methods, such as, without limitation, explicit or implicit finite-difference methods, explicit or implicit finite element methods, or discrete Galerkin methods.

The fluid flow and production scenarios (116) predicted by the reservoir simulator (114) may then be used by the wellbore planning system (118) to determine the wellbore drilling plan (120).

While a wellbore drilling plan (120) is formed using the best available information at the time at which it is formed, additional information may become available when drilling the wellbore specified by the plan. For example, well logs providing new information about the reservoir structure and characteristic may be acquired while drilling (so-called “logging-while-drilling” (LWD) logs or during drilling pauses in, or at the completion of drilling of, a wellbore specified by the drilling plan (120). These well logs acquired during pauses or at the cessation of drilling may be acquired using wireline or coiled tubing conveyed logging tools. However acquired, these new wells may be used to update geological and reservoir models (112) with the aid of a seismic interpretation workstation or to directly update the reservoir simulation performed by the reservoir simulator (114).

FIG. 1B illustrates a seismic surveying system (100) and various resultant paths of pressure waves (also called seismic waves). The seismic surveying system (100) includes a seismic source (122) that includes functionality for generating pressure waves, such as a reflected wave (136), diving wave A (142), or diving wave B (146), through a subsurface layer (124). Pressure waves generated by the seismic source (122) may travel along several paths through a subsurface layer (124) at a velocity V₁ for detection at a number of seismic receivers (126) along the line of profile. Likewise, velocity may refer to multiple velocities types, such as the two types of particle motions resulting from a seismic wave, i.e., velocity of the primary wave (P-wave) and a different velocity of the secondary wave (S-wave) through a particular medium. The seismic source (122) may be a seismic vibrator, such as one that uses a vibroseis technique, an air gun in the case of offshore seismic surveying, explosives, etc. The seismic receivers (126) may include geophones, hydrophones, accelerometers, and other sensing devices. Likewise, seismic receivers (126) may include single component sensors and/or multi-component sensors that measure pressure waves in multiple spatial axes.

As shown in FIG. 1B, the seismic source (122) generates an air wave (128) formed by a portion of the emitted seismic energy, which travels above the earth's surface (130) to the seismic receivers (126). The seismic source (122) may also emit surface waves (132), which travel along the earth's surface (130). The speed of the surface waves (132), also called Rayleigh waves or ground roll, may correspond to a velocity typically slower than the velocity of a secondary wave. While the seismic surveying shown in FIG. 1B is a two-dimensional survey along a seismic profile along a longitudinal direction, other embodiments are contemplated, such as three-dimensional surveys.

Furthermore, subsurface layer (124) has a velocity V₁, while subsurface layer (140) has a velocity V₂. In words, different subsurface layers may correspond to different velocity values. In particular, a velocity may refer to the speed that a pressure wave travels through a medium, e.g., diving wave B (146) that makes a curvilinear ray path (148) through subsurface layer (124). Velocity may depend on a particular medium's density and elasticity as well as various wave properties, such as the frequency of an emitted pressure wave. Where a velocity differs between two subsurface layers, this seismic impedance mismatch may result in a seismic reflection of a pressure wave. For example, FIG. 1B shows a pressure wave transmitted downwardly from the seismic source (122) to a subsurface interface (138), which becomes a reflected wave (136) transmitted upwardly in response to the seismic reflection. The seismic source (122) may also generate a direct wave (144) that travels directly from the seismic source (122) at the velocity V₁ through the subsurface layer (124) to the seismic receivers (126).

Turning to refracted pressure waves, the seismic source (122) may also generate a refracted wave (i.e., diving wave A (142)) that is refracted at the subsurface interface (138) and travels along the subsurface interface (138) for some distance as shown in FIG. 1 until traveling upwardly to the seismic receivers (126). As such, refracted pressure waves may include diving waves (e.g., diving wave A (142), diving wave B (146)) that may be analyzed to map the subsurface layers (124, 140). For example, a diving wave may be a type of refracted wave that is continuously refracted throughout an earth's subsurface. Thus, a diving wave may be generated where velocities are gradually increasing with depth at a gradient. Likewise, the apex of a diving wave may be offset from a common midpoint (CMP) in contrast to reflected seismic energy. Though, for analysis purposes, an apex (or turning point) of a diving wave may be regarded as a common midpoint for the refracted energy. As such, the apex may serve as the basis for organizing and sorting a seismic survey dataset.

Furthermore, in analyzing seismic data acquired using the seismic surveying system (100), seismic wave propagation may be approximated using rays. For example, reflected waves (e.g., reflected wave (136)) and diving waves (e.g., diving waves (142, 146)) may be scattered at the subsurface interface (138). In the example of FIG. 1B, the diving wave B (146) may exhibit a ray path of a wide angle that resembles a reflected wave in order to map the subsurface. Using diving waves, for example, a velocity model for an underlying subsurface may be generated that describes the velocity of different regions in different subsurface layers, An initial velocity model may be generated by modeling the velocity structure of media in the subsurface using an inversion of seismic data, typically referred to as seismic inversion. In seismic inversion, a velocity model is iteratively updated until the velocity model and the seismic data have a minimal amount of mismatch, e.g., the solution of the velocity model converges to a minimum that satisfies a predetermined criterion. For example, the optimization algorithm may be “linearized” and, while achieving a “minimum”, there may be no guarantee that the solution is a global minimum rather than a local minimum. Thus, it may be a simplification commonly adapted in solving inverse problems that works when a respective objective function is convex.

With respect to velocity models, a velocity model may map various subsurface layers based on velocities in different layer sub-regions (e.g., P-wave velocity, S-wave velocity, and various anisotropic effects in the sub-region). For example, a velocity model may be used with P-wave and S-wave arrival times and arrival directions to locate seismic events. Anisotropy effects may correspond to subsurface properties that cause pressure waves to be directionally dependent. Thus, seismic anisotropy may correspond to various parameters in geophysics that refers to variations of wave velocities based on direction of propagation. One or more anisotropic algorithms may be performed to determine anisotropic effects, such as an anisotropic ray-tracing location algorithm or algorithms that use deviated-well sonic logs, vertical seismic profiles (VSPs), and core measurements. Likewise, a velocity model may include various velocity boundaries that define regions where rock types changes, such as interfaces between different subsurface layers. In some embodiments, a velocity model is updated using one or more tomographic updates to adjust the velocity boundaries in the velocity model.

FIG. 2A shows a seismic acquisition system (200) configured to acquiring a seismic dataset pertaining to a subterranean region of interest (202). The subterranean region of interest (202) may or may not contain a hydrocarbon reservoir (204). The purpose of the seismic survey may be to determine whether or not a hydrocarbon reservoir (204) is present within the subterranean region of interest (202).

The seismic acquisition system (200) may utilize a seismic source (206) positioned on the surface of the earth (216). On land the seismic source (206) is typically a vibroseis truck (as shown) or, less commonly, explosive charges, such as dynamite, buried to a shallow depth. In water, particularly in the ocean, the seismic source may commonly be an airgun (not shown) that releases a pulse of high-pressure gas when activated. Whatever its mechanical design, the seismic source (206), when activated, generates radiated seismic waves, such as those whose paths are indicated by the rays (208). The radiated seismic waves may be bent (“refracted”) by variations in the speed of seismic wave propagation within the subterranean region (202) and return to the surface of the earth (216) as refracted seismic waves (210). Alternatively, radiated seismic waves may be partially or wholly reflected by seismic reflectors, at reflection points such as (224), and return to the surface as reflected seismic waves (214). Seismic reflectors may be indicative of the geological boundaries (212), such as the boundaries between geological layers, the boundaries between different pore fluids, faults, fractures or groups of fractures within the rock, or other structures of interest in the seismic for hydrocarbon reservoirs.

At the surface, the refracted seismic waves (210) and reflected seismic waves (214) may be detected by seismic receivers (220). On land a seismic receiver (220) may be a geophone (that records the velocity of ground motion) or an accelerometer (that records the acceleration of ground motion). In water, the seismic receiver may commonly be a hydrophone that records pressure disturbances within the water. Irrespective of its mechanical design or the quantity detected, seismic receivers (220) convert the detected seismic waves into electrical signals, that may subsequently be digitized and recorded by a seismic recorder (222) as a time-series of samples. Such a time-series is typically referred to as a seismic “trace” and represents the amplitude of the detected seismic wave at a plurality of sample times. Usually, the sample times are referenced to the time of source activation and the sample times are referred to as “recording times”. Thus, zero recording time occurs at the moment the seismic source is activated.

Each seismic receiver (220) may be positioned at a seismic receiver location that may be denoted (xᵣ, yᵣ) where x and y represent orthogonal axes, such as North-South and East-West, on the surface of the earth (216) above the subterranean region of interest (202). Thus, the refracted seismic waves (210) and reflected seismic waves (214) generated by a single activation of the seismic source (206) may be represented as a three-dimensional “3D” volume of data with axes (xᵣ, yᵣ, t) where t indicates the recording time of the sample, i.e., the time after the activation of the seismic source (206).

Typically, a seismic survey includes recordings of seismic waves generated by one or more seismic sources (206) positioned at a plurality of seismic source locations denoted (xₛ, yₛ). In some case, a single seismic source (206) may be used to acquire the seismic survey, with the seismic source (206) being moved sequentially from one seismic source location to another. In other cases, a plurality of seismic sources, such as seismic source (206) may be used, each occupying and being activated (“fired”) sequential at a subset of the total number of seismic source locations used for the survey (218). Similarly, some or all of the seismic receivers (220) may be moved between firing of the seismic source (206). For example, seismic receivers (220) may be moved such that the seismic source (206) remains at the center of the area covered by the seismic receivers (220) even as the seismic source (206) is moved from one seismic source location to the next. In other cases, such as marine seismic acquisition (not shown) the seismic source may be towed a short distance behind a seismic vessel and strings of receivers attached to multiple cables (“streamers”) are towed behind the seismic sources. Thus, a seismic dataset, the aggregate of all the seismic data acquired by the seismic survey, may be represented as a five-dimensional volume (four space dimensions and one time dimension) with coordinate axes (xᵣ, yᵣ, yₛ, yₛ, t).

FIG. 2B illustrates an example system used by implementations of the present disclosure. As illustrated, a seismic volume (290) is illustrated that includes various seismic traces (e.g., seismic traces (250)) acquired by various seismic receivers (e.g., seismic receivers (226)) disposed on the earth's surface (230). More specifically, a seismic volume (290) may be a cubic dataset of seismic traces. In particular, seismic data may have up to four spatial dimensions, one temporal dimension (i.e., related to the actual measurements stored in the traces), and possibly another temporal dimension related to time-lapse seismic surveys. Individual cubic cells within the seismic volume (290) may be referred to as voxels or volumetric pixels (e.g., voxels (260)). In particular, different portions of a seismic trace may correspond to various depth points within a volume of earth. To generate the seismic volume (290), a three-dimensional array of seismic receivers (226) are disposed along the earth's surface (230) and acquire seismic data in response to various pressure waves emitted by seismic sources. Within the voxels (260), statistics may be calculated on first break data that is assigned to a particular voxel to determine multimodal distributions of wave travel times and derive travel time estimates (e.g., according to mean, median, mode, standard deviation, kurtosis, and other suitable statistical accuracy analytical measures) related to azimuthal sectors. First break data may describe the onset arrival of refracted waves or diving waves at the seismic receivers (226) as produced by a particular seismic source signal generation.

Seismic data may refer to raw time domain data acquired from a seismic survey (e.g., acquired seismic data may result in the seismic volume (290)). However, seismic data may also refer to data acquired over different periods of time, such as in cases where seismic surveys are repeated to obtain time-lapse data. Seismic data may also refer to various seismic attributes derived in response to processing acquired seismic data. Furthermore, in some contexts, seismic data may also refer to depth data or image data. Likewise, seismic data may also refer to processed data, e.g., using a seismic inversion operation, to generate a velocity model of a subterranean formation, or a migrated seismic image of a rock formation within the earth's surface. Seismic data may also be pre-processed data, e.g., arranging time domain data within a two-dimensional shot gather.

Furthermore, seismic data may include various spatial coordinates, such as (x,y) coordinates for individual shots and (x,y) coordinates for individual receivers. As such, seismic data may be grouped into common shot or common receiver gathers. In some embodiments, seismic data is grouped based on a common domain, such as common midpoint (i.e., Xmidpoint=(Xshot+Xrec)/2, where Xshot corresponds to a position of a shot point and Xrec corresponds to a position of a seismic receiver) and common offset (i.e., Xoffset=Xshot−Xrec).

In some implementations, seismic data is processed to generate one or more seismic images. For example, seismic imaging may be performed using a process called migration. In some embodiments, migration may transform pre-processed shot gathers from a data domain to an image domain that corresponds to depth data. In the data domain, seismic events in a shot gather may represent seismic events in the subsurface that were recorded in a field survey. In the image domain, seismic events in a migrated shot gather may represent geological interfaces in the subsurface. Likewise, various types of migration algorithms may be used in seismic imaging. For example, one type of migration algorithm corresponds to reverse time migration. In reverse time migration, seismic gathers may be analyzed by: 1) forward modelling of a seismic wavefield via mathematical modelling starting with a synthetic seismic source wavelet and a velocity model; 2) backward propagating the seismic data via mathematical modelling using the same velocity model; 3) cross-correlating the seismic wavefield based on the results of forward modeling and backward propagating; and 4) applying an imaging condition during the cross-correlation to generate a seismic image at each time step. The imaging condition may determine how to form an actual image by estimating cross-correlation between the source wavefield with the receiver wavefield under the basic assumption that the source wavefield represents the down-going wave-field and the receiver wave-field the up-going wave-field. In Kirchhoff and beam methods, for example, the imaging condition may include a summation of contributions resulting from the input data traces after the traces have been spread along portions of various isochrones (e.g., using principles of constructive and destructive interference to form the image).

Furthermore, seismic data processing may include various seismic data functions that are performed using various process parameters and combinations of process parameter values. For example, a seismic interpreter may test different parameter values to obtain a desired result for further seismic processing. Depending on the seismic data processing algorithm, a result may be evaluated using different types of seismic data, such as directly on processed gathers, Normal Move Out (NMO) corrected stacks of those gathers, or on migrated stacks using a migration function. Where structural information of the subsurface is being analyzed, migrated stacks of data may be used to evaluate seismic noise that may overlay various geological boundaries in the subsurface, such as surface multiples (e.g., strong secondary reflections that are detected by seismic receivers). As such, migrated images may be used to determine impact of noise removal processes, while the same noise removal processes may operate on gather data.

Keeping with seismic imaging, seismic imaging may be near the end of a seismic data workflow before an analysis by a seismic interpreter. The seismic interpreter may subsequently derive understanding of the subsurface geology from one or more final migrated images. In order to confirm whether a particular seismic data workflow accurately models the subsurface, a normal moveout (NMO) stack may be generated that includes various NMO gathers with amplitudes sampled from a common midpoint (CMP). In particular, a NMO correction may be a seismic imaging approximation based on calculating reflection travel times. However, NMO-stack results may not indicate an accurate subsurface geology, where the subsurface geology is complex with large heterogeneities in velocities or when a seismic survey is not acquired on a horizontal plane. Ocean-Bottom-Node surveys and rough topographic land seismic surveys may be examples where NMO-stack results fail to depict subsurface geologies.

While seismic traces with zero offset are generally illustrated in FIG. 2B, seismic traces may be stacked, migrated and/or used to generate an attribute volume derived from the underlying seismic traces. For example, an attribute volume may be a dataset where the seismic volume undergoes one or more processing techniques, such as amplitude-versus-offset (AVO) processing. In AVO processing, seismic data may be classified based on reflected amplitude variations due to the presence of hydrocarbon accumulations in a subsurface formation. With an AVO approach, seismic attributes of a subsurface interface may be determined from the dependence of the detected amplitude of seismic reflections on the angle of incidence of the seismic energy. This AVO processing may determine both a normal incidence coefficient of a seismic reflection, and/or a gradient component of the seismic reflection. Likewise, seismic data may be processed according to a pressure wave's apex. In particular, the apex may serve as a data gather point to sort first break picks for seismic data records or traces into offset bins based on the survey dimensional data (e.g., the x-y locations of the seismic receivers (226) on the earth surface (230)). The bins may include different numbers of traces and/or different coordinate dimensions.

Turning to the seismic interpreter (261), a seismic interpreter (261) (also called a “seismic processing system”) may include hardware and/or software with functionality for storing the seismic volume (290), well logs, core sample data, and other data for seismic data processing, well data processing, and other data processes accordingly. In some embodiments, the seismic interpreter (261) may include a computer system that is similar to the computer (800) described below with regard to FIG. 8 and the accompanying description.

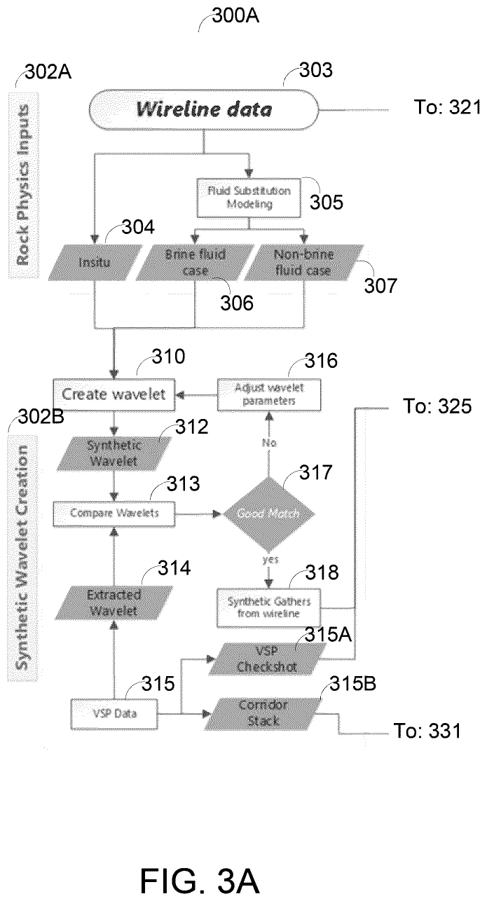

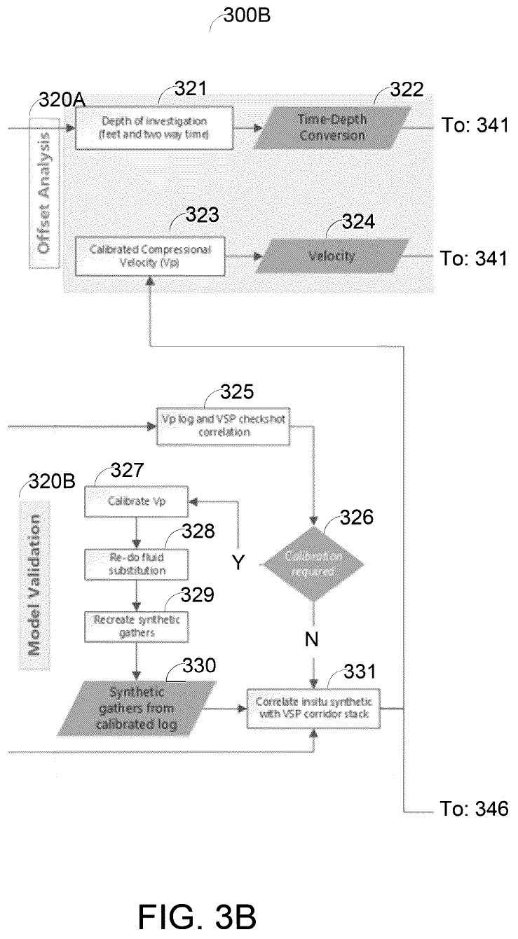

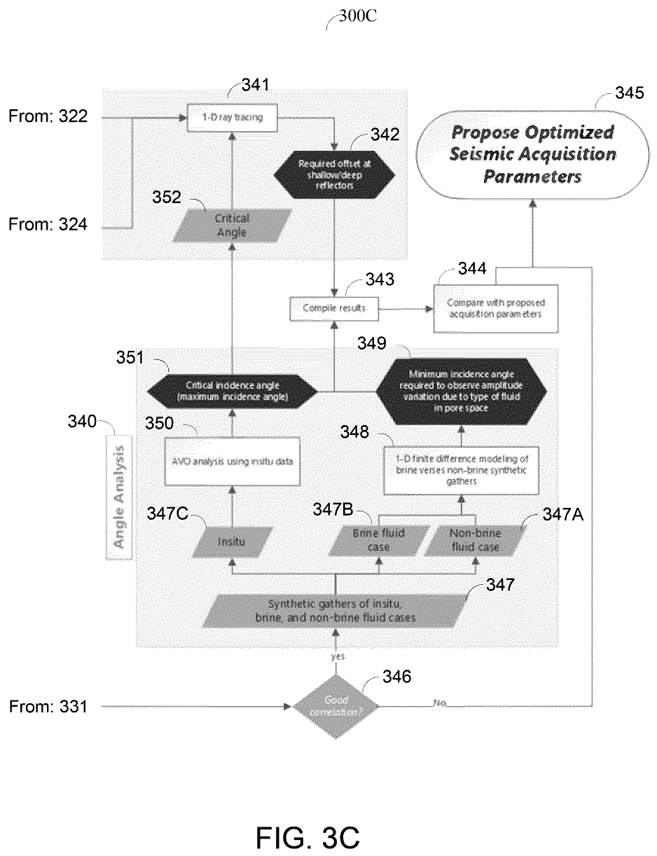

FIG. 3A to 3C shows an example of a diagram according to some implementations of the present disclosure. In this example, the diagram includes three sections, namely section 300A for data loading (FIG. 3A), section 300B for QC and validation processes (FIG. 3B), and section 300C for 1-D finite difference modeling (FIG. 3C).

In section 300A of this example, wireline data 303 is initially loaded into an input space of a computer system for seismic data analysis. As illustrated, the wireline data 303 can be provided in-situ (304), for example, using sensors and instruments mounted on the wire lowered into the borehole that yield measurements data transmitted to the surface in real-time. Portions of the wireline data 303 can also be provided to fluid substitution modeling 305 to generate results for a first case (306) and a second case (307). Case 306 involves brine fluid (for example, fluid with a high-concentration solution of salt, typically sodium chloride or calcium chloride), which is often considered a representative of water-saturated formations. Brine has a relatively high density and is a good conductor of electrical currents. The salinity of brine affects its acoustic properties, including its compressional (P-wave) velocity and density. Brine fluids are commonly used as a reference fluid in fluid substitution models, particularly when simulating the effects of water saturation in porous rocks.

Case 307 involves a non-brine fluid, which include a type of fluid other than water with dissolved salts. Examples may include hydrocarbons (oil and gas) and other fluids commonly found in subsurface reservoirs. The acoustic properties of non-brine fluids, such as oil and gas, vary from those of brine. These variations can impact the ability for accurately predicting seismic responses in reservoirs with different fluid compositions. Non-brine fluids are used in fluid substitution models to simulate scenarios where hydrocarbons or other non-aqueous fluids replace brine in subsurface formations. Implementations can also consider mixtures of fluids with different properties to simulate a reservoir where a combination of brine, oil, and gas is present.

The wireline data 303 and results from case 306 and 307 jointly provides rock physics inputs 302A for subsequent synthetic wavelet creation 310 in section 302B (synthetic wavelet creation). Here, synthetic wavelet 312 can be created using different methodologies to provide, for example, the Ricker wavelet or the Ormsby wavelet. The Ricker wavelet is also known as the Mexican Hat wavelet, which often has distinctive shape resembling a symmetric, bell-shaped curve. The Ormsby Wavelet is often characterized by a bandpass feature, thereby allowing a certain range of frequencies to pass through while attenuating frequencies outside that range. In block 313, the synthetic wavelet 312 can be compared with the extracted wavelet 314 from the VSP data 315. As discussed above with reference to FIGS. 1A to 2B, VSP checkshot velocity is obtained from, e.g., a borehole seismic receiver that measure velocity of sound that travels from a seismic source on the surface to the receiver within the borehole. In block 317, the workflow in some implementations can determine whether a good match exists between the synthetic wavelet 312 and the extracted wavelet 314. In response to determining that there is no good match, the workflow may adjust wavelet parameters (316). In response to determining that there is good match, the workflow may proceed to provide synthetic gathers from the wireline data 318. Based on synthetic gathers from the wireline data 318, VSP checkshot data 315A and corridor stack data 315B, the workflow may proceed to section 300B for quality control (QC) and validation process.

Referring to FIG. 3B, synthetic gathers from the wireline data 318, along with VSP checkshot data 315A and corridor stack data 315B are provided to the Vp log and the VSP checkshot correlation module 325, which is part of the model validation section 320B. In this section 320B, the checkshot interval velocity and logged Vp are compared to confirm these are well correlated and may not need calibration. As discussed above with reference to FIGS. 1A to 2B, in the context of wireline logging and geophysics, “logged Vp” refers to the compressional wave velocity, often denoted as Vp, that is measured and recorded using a wireline tool. Compressional wave velocity represents the speed at which compressional (P-wave) seismic waves travel through the subsurface materials. The logged Vp is obtained through acoustic or sonic logging, where a sonic tool is deployed on a wireline into a borehole. The sonic tool emits compressional waves into the surrounding formations, and the time it takes for these waves to travel from the source to receivers (geophones or accelerometers) is measured. The logged Vp values are typically recorded at different depths in the borehole, creating a Vp log that provides a vertical profile of compressional wave velocities with respect to depth.

The workflow may then determine whether calibration may still be required for the Vp log. In response to determining that calibration is still required, the workflow may proceed to calibrate Vp (327). For example, the wireline Vp may be compared to the interval velocity from VSP checkshot. The difference between these velocity values can be identified. A new Vp value can be calculated at a depth point where there is such difference between these velocities. The new Vp values may then be interpolated above and below the corrected depth point. A new calibrated Vp log can be generated after splicing data points at other depth points in the logged Vp that are being similarly corrected.

Subsequent to calibration, the fluid substitution modeling (e.g., block 305 at FIG. 3A) can be re-done at block 328, which recreates synthetic gathers 329. Such recreated synthetic gathers from the calibrated log (330) can then be correlated in situ (331) with synthetic corridor stack (e.g., received from block 315B at FIG. 3A).

The workflow may proceed to offset analysis (section 320A) to provide calibrated compressional velocity (Vp) in block 323, which provides calibrated velocity 324 at each depth point. Additionally, the wireline data 303 (e.g., from section 300A of FIG. 3A) may also drive offset analysis 320A. For example, the wireline data 303 may drive depth of investigation 321 to provide time-depth conversion 322 in which the time scale is converted to a matching depth scale.

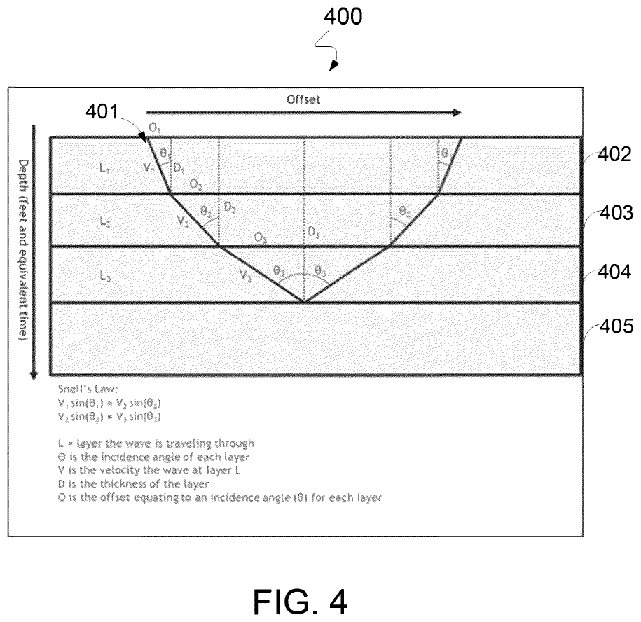

Calibrated velocity 324 and results of time-depth conversion 322 are provided to 1-D ray tracing 341, which can determine the offset required for shallow and deep reflection in a reservoir model (342). Referring to FIG. 4 showing a diagram 400 where an acoustic wave 401 enters a number of layers of underground formation, namely, layer 402, layer 403, layer 404, and layer 404. Because the physical and mechanical properties (e.g., density and speed of sound) of each layer vary, acoustic wave 401 follows a trajectory by bending at the interface of each layer between neighboring layers. Significantly, when acoustic wave 401 bounces off the interface between layers 404 and 405, the returning trajectory is symmetrical with respect to the incoming trajectory. When acoustic wave 401 exits the layered formations, the distance between the entry point and the exit point is known as offset, as illustrated in FIG. 4. For a given incidence angle at the entry point at the surface, this offset varies, depending on the depth position of the shallowest and deepest bouncing point. When the depth position is relatively shallow, a smaller offset can be achieved. When the depth position is relatively deep, a larger offset can accommodate the trajectory of the acoustic wave 401 that travels through the layers to bounce off the depth position. This offset parameter is the parameter determined at block 342 of FIG. 3C.

Further referring to FIGS. 3A to 3C, when recreated synthetic gathers from the calibrated log (330) is correlated in situ (331) with synthetic corridor stack (e.g., received from block 315B at FIG. 3A based on VSP data 315 in situ), the quality of the correlation can be compared to a threshold (346). Responsive to the quality being not satisfactory, the workflow may proceed to generate and output the proposed acquisition parameters that can optimize seismic acquisition operations at the site where VSP profiling has been performed.

When the correlation result quality is satisfactory, the workflow may proceed to perform angle analysis (340). For example, a computer system may generate synthetic gathers (347) for in-situ conditions (347C), brine fluid case (347B), and non-brine fluid case (347A). The synthetic gathers for brine fluid case and non-brine fluid case may provide input to 1-D finite difference modeling (348) for comparing brine fluid case and non-brine fluid case. The 1D finite difference modeling can predict the minimum incidence angle (349) that may be required to observe amplitude variation due to type of fluid in pore space. As also illustrated in FIG. 4, this minimum incidence angle refers to the smallest incidence angle to launch acoustic wave 401 into a desired depth. In block 350, the workflow may also drive amplitude-versus-offset (AVO) analysis using the in-situ data 347C to predict a maximum incidence angle, also known as the critical angle, which refers to the angle of incidence at which the compressional wave (e.g., acoustic wave 401) is refracted along the interface between two subsurface layers, and the reflected wave emerges at the critical angle. Below the critical angle, the wave is transmitted through the interface; above the critical angle, the wave is reflected. The critical angle plays a significant role in AVO analysis because the angle of incidence affects the amplitude of the reflected seismic wave. Above the critical angle, the amplitude of the reflected wave tends to increase, and this behavior contributes to specific patterns observed in AVO response. This predicted critical incidence angle at block 351 can be the critical angle 352 that provides input to the 1D ray tracing module 341. Additionally, the predicted critical incidence angle 351, the predicted minimum incidence angle 349, and the predicted offset parameter 342 are compared (343). In some cases, these predicted parameters (e.g., the predicted critical incidence angle 351, the predicted minimum incidence angle 349, and the predicted offset parameter 342 are compared with proposed acquisition parameters (344), for example, to determine whether the acquisition parameters are within the limits of these predicted parameters for a more fulsome investigation of the geo-exploration site using tools such as VSP wireline tools. Based on the comparison results, optimized seismic acquisition parameters can be proposed (345).

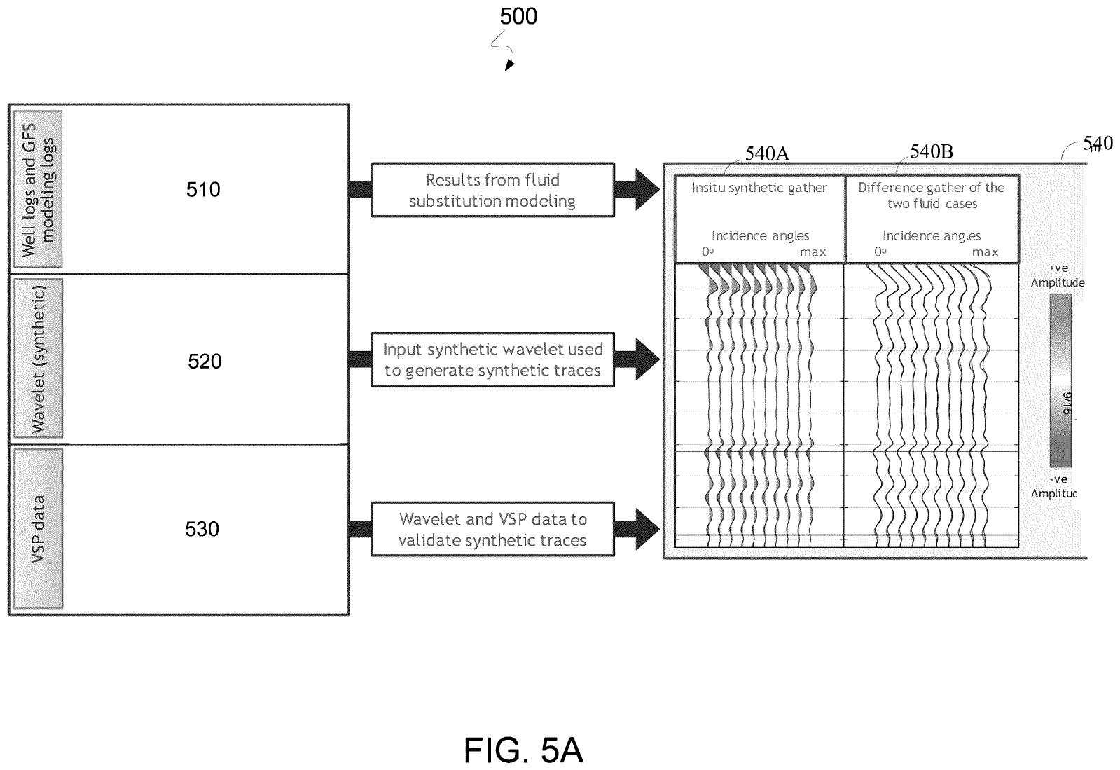

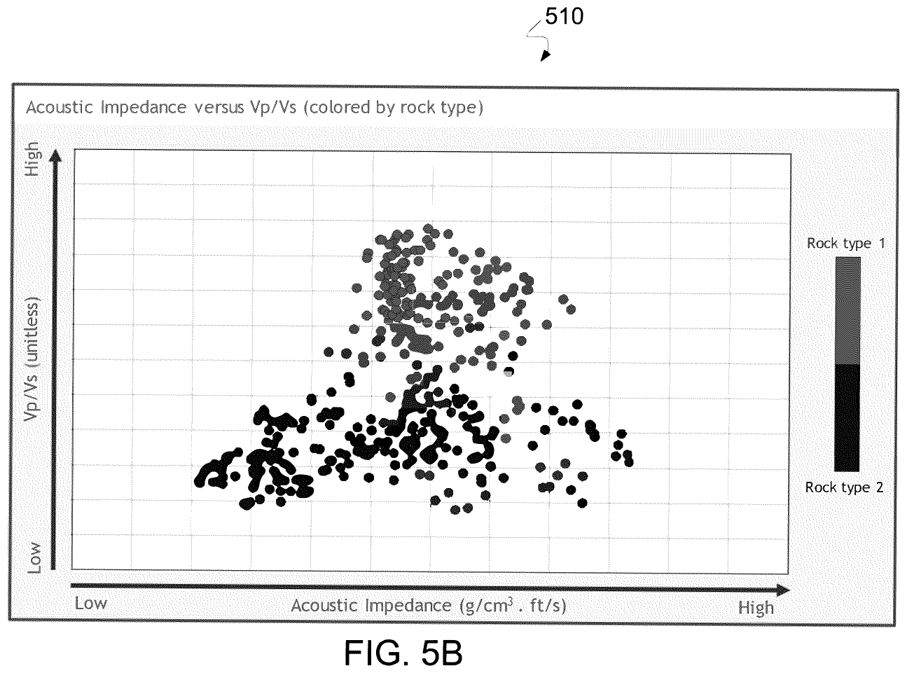

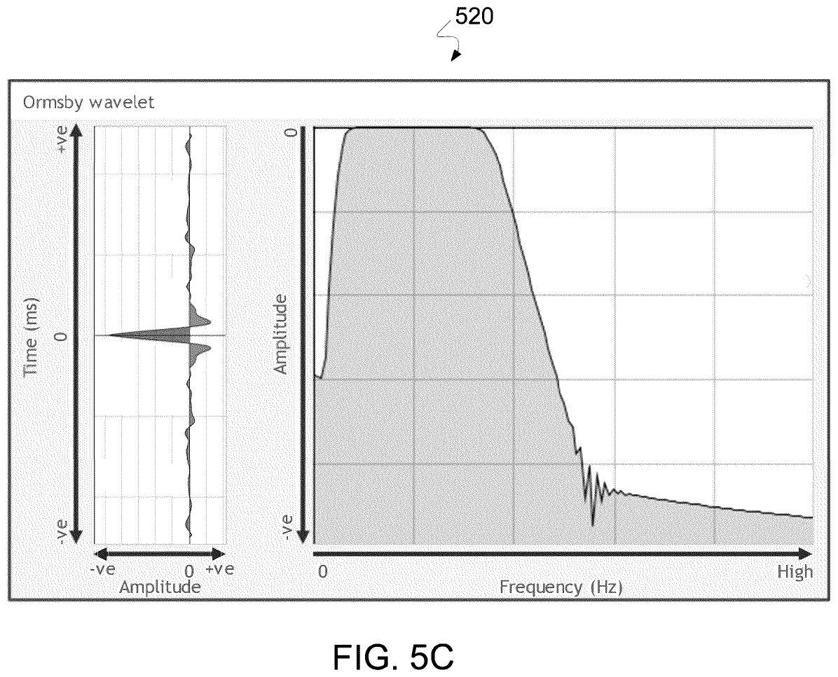

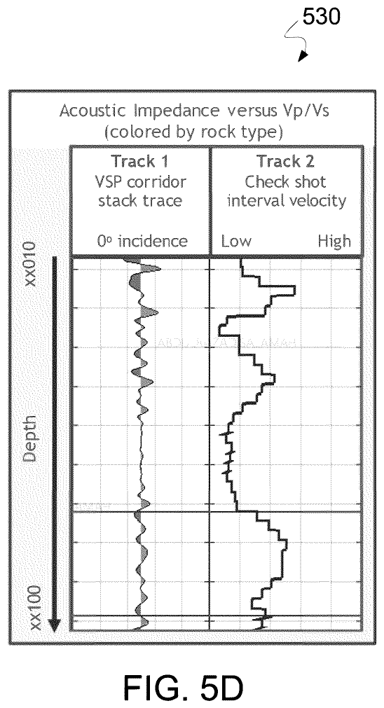

FIGS. 5A to 5D shows diagram 500 providing examples of data generated at various stages during the workflow diagram of FIGS. 3A to 3C. Some implementations of the present disclosure apply rock physics modeling techniques including, for example, AVO and fluid substitution modeling, to evaluate the quality of a proposed seismic survey in a given location, to ensure the parameters will meet the requirements for adequate interpretation. Block 510 at FIG. 5B provides an example of results from fluid substitution modeling, which shows the estimated ratio of compressional velocity (Vp) over shear velocity (Vs) as a function of acoustic impedance. As explained above with reference to block 305 in FIG. 3A, wireline data 303 can be provided to fluid substitution modeling 305 to generate results for various cases including, for example, brine fluid and non-brine fluid.

Some implementations may create synthetic wavelets based on rock physics input, as explained above with reference to section 302B of FIG. 3A. Block 520 at FIG. 5C provides an example of synthetic wavelet created using the methodology of the Ormsby wavelet, which is often characterized by a bandpass feature. The left panel of block 520 shows the synthetic wavelet in temporal domain whereas the right panel of block 520 shows the synthetic wavelet in the frequency domain, demonstrating the bandpass feature.

Some implementations may load VSP data and wavelet extracted from the VSP data, as shown in blocks 315 and 314 of FIG. 3A, to create synthetic wavelets for generating synthetic gathers. The VSP data may include corridor stack data, check shot interval velocity data. Block 530 at FIG. 5D shows examples of a VSP corridor stack trace in track 1, and a check shot interval velocity in track 2.

Based on the rock physics fluid substitution modeling results, the synthetic wavelets created using rock physics input, as well as the VSP data and the wavelet extracted from the VSP data, the workflow performs validation in which the fluid substituted logs are convolved with the synthetic wavelet so that the AVO response at different angles can be modeled. As explained in more detail with reference to FIGS. 3A, 3B, 3C and 4 above, after validation, the workflow can perform 1-D finite difference modeling to establish a minimum incidence angle under which the modeled fluid show amplitude variation with respect to angle, as well as a maximum incidence angle (critical angle) above which the amplitude of the reflected wave tends to increase. Using the established angles, and horizons of interest, minimum and maximum offset can also be determined (e.g., by using a homogeneous layer cake model with constant lateral velocity in each formation). As illustrated in FIG. 5A, block 540 show examples of in-situ synthetic gathers in subpanel 540A and difference gathers of brine and non-brine cases in subpanel 540B. In both areas, the behavior of the gathers are presented as an array of traces when the incidence angle changes. In subpanel 540A, the offset gather is plotted with offsets ‘up-to’ the critical angle. In particular, the “max” refers to the offset related to the critical angle. Subpanel 540B shows a difference gather up to the critical angle. Again here, the “max” refers to the offset related to the critical angle. The difference between subpanel 540A and subpanel 540B is that subpanel 540B shows the difference in amplitude between two fluid cases resulting from Gassmann Fluid Substitution (generally water and hydrocarbons).

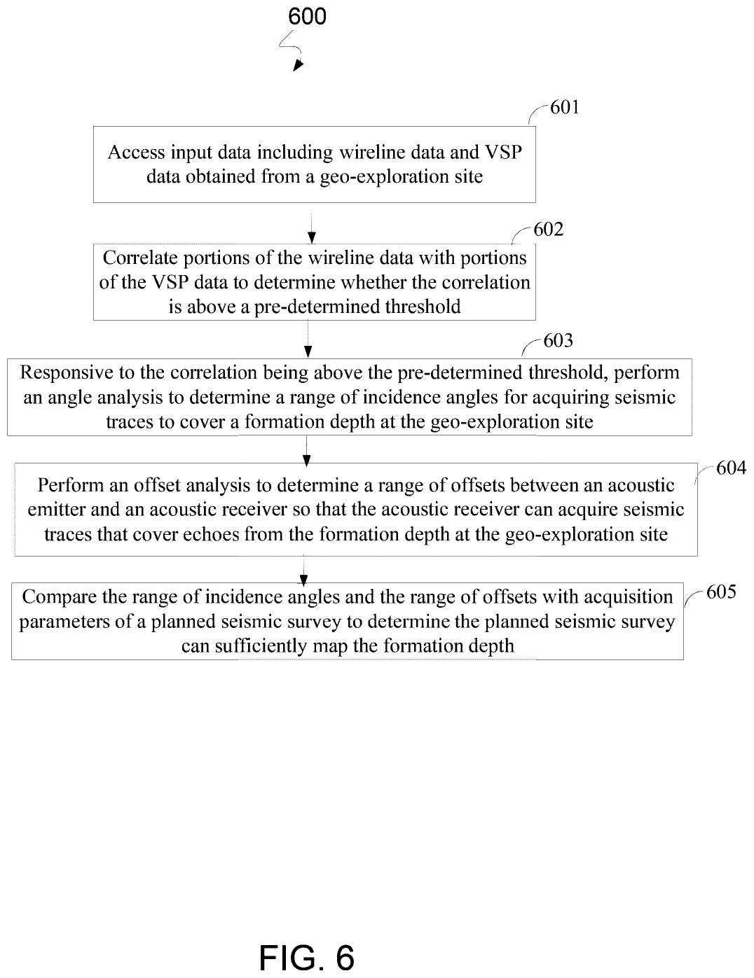

FIG. 6 shows an example of a flow chart 600 for integrating seismic measurement, vertical seismic profiling (VSP), rock physics fluid substitution modeling and amplitude versus offset (AVO) modeling to evaluate seismic acquisition parameters according to some implementations.

In block 601, input data are imported into, e.g., the project space on a computer system. Examples of input data may include wireline data, VSP data, and modeling data. Wireline data refers to data collected through borehole logging using a wireline tool. Wireline data can cover a plethora of measurements including caliper log, gamma ray, neutron porosity, total porosity, total saturation, resistivity, compressional sonic log (Vp), shear log (Vs), and directional data (well inclination and azimuth). VSP refers to measurements and information collected from a VSP operation, which involves deploying seismic sensors (geophones or accelerometers) in a borehole and using a seismic source at the surface or another location to generate seismic waves. The wireline data can provide input data driving rock physics modeling to provide results, such as the estimate the elastic response (Vp, Vs, Density logs) across a borehole. An example of rock physics modeling is fluid substitution modeling for predicting how changes in fluid content within the reservoir can impact the amplitudes, velocities, and other attributes of seismic waves. Additional details can be found above with reference to FIG. 3A.

In block 602, the imported data are correlated for quality control (QC) and validation. For example, the checkshot interval velocity from the VSP data, and logged Vp from the wireline data can be compared to determine whether the checkshot interval velocity and logged Vp are well correlated above a pre-determined threshold. If so, a synthetic wavelet is created using an extracted wavelet that is based on the wireline data; and the synthetic wavelet is correlated with the corridor stack, created by stacking traces within a narrow corridor or window along the shot and receiver lines. If the logged Vp still needs calibration, the logged Vp is used as input to recreate fluid substitution model logs and, based on the model logs, recreate synthetic gathers for correlation with VSP corridor stack until the correlation result is satisfactory. Additional details can be found above with reference to FIGS. 3A and 3B.

When the correlation results are satisfactory, an angle analysis is performed in block 603. A computer system may generate synthetic gathers for the in-situ conditions, brine fluid case, and non-brine fluid case. The synthetic gathers for the brine fluid case and non-brine fluid case may provide input to the 1-D finite difference modeling for comparing the brine fluid case and the non-brine fluid case and also predict the minimum incidence angle for observing an amplitude variation due to the type of fluid in the pore space. The computer system may also drive an amplitude-versus-offset (AVO) analysis using the in-situ data to predict a maximum incidence angle, i.e., the critical angle, beyond which the amplitude of the reflected wave tends to increase. More details can be found above with reference to FIGS. 3B-3C.

In block 604, the computer system may also perform offset analysis, for example, using ray tracing and based on the calibrated velocity log, to evaluate the offset (between pairs of emitter-receiver) required to achieve both minimum and maximum incidence angle at a given location at the geo-exploration site. More details can be found above with reference to FIGS. 3B-3C and 4.

In block 605, the computer system may compare the results of minimum and maximum incidence angle, as well as the corresponding offset, with proposed seismic acquisition parameters to determine whether the proposed seismic survey can adequately cover the geological features at the geo-exploration site (e.g., whether the survey can map the deepest formation layer under investigation in the reservoir of the geo-exploration site). When comparing the results with proposed seismic parameters, suggestions can be provided so that the proposed seismic survey may have the acquisition parameters modified accordingly.

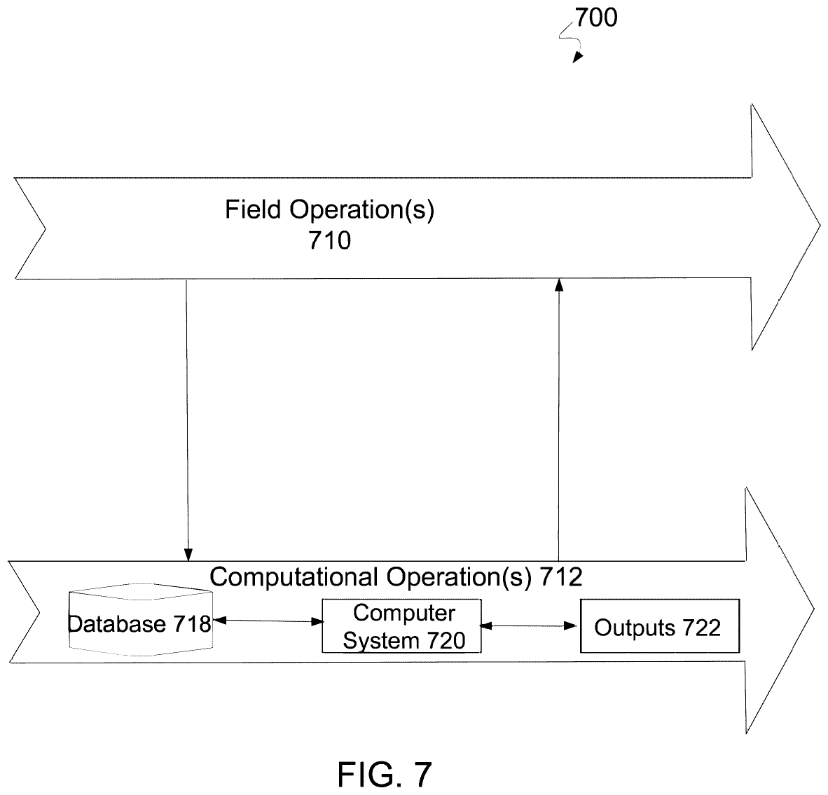

FIG. 7 illustrates hydrocarbon exploration and production operations 700 that include both one or more field operations 710 and one or more computational operations 712, which exchange information and control exploration for the exploration and production of hydrocarbons. In some implementations, outputs of techniques of the present disclosure can be performed before, during, or in combination with the hydrocarbon exploration and production operations 700, specifically, for example, either as field operations 710 or computational operations 712, or both.

Examples of field operations 710 include surveying operations, forming/drilling a wellbore, hydraulic fracturing, producing through the wellbore, injecting fluids (such as water) through the wellbore, to name a few. In some implementations, methods of the present disclosure can trigger or control the field operations 710. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 710 and responsively triggering the field operations 710 including, for example, generating plans and signals that provide feedback to and control physical components of the field operations 710. Alternatively, or in addition, the field operations 710 can trigger the methods of the present disclosure. For example, implementing physical components (including, for example, hardware, such as sensors) deployed in the field operations 710 can generate plans and signals that can be provided as input or feedback (or both) to the methods of the present disclosure.

Examples of computational operations 712 include one or more computer systems 720 that include one or more processors and computer-readable media (e.g., non-transitory computer-readable media) operatively coupled to the one or more processors to execute computer operations to perform the methods of the present disclosure. A more detailed example can be found in FIG. 8. The computational operations 712 can be implemented using one or more databases 718, which store data received from the field operations 710 and/or generated internally within the computational operations 712 (e.g., by implementing the methods of the present disclosure) or both. For example, the one or more computer systems 720 process inputs from the field operations 710 to assess conditions in the physical world, the outputs of which are stored in the databases 718. For example, seismic sensors of the field operations 710 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 712 where they are stored in the databases 718 and analyzed by the one or more computer systems 720.

In some implementations, one or more outputs 722 generated by the one or more computer systems 720 can be provided as feedback/input to the field operations 710 (either as direct input or stored in the databases 718). The field operations 710 can use the feedback/input to control physical components used to perform the field operations 710 in the real world.

For example, the computational operations 712 can process the seismic data to generate three-dimensional (3D) maps of the subsurface formation. The computational operations 712 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 712 to process new information about the formation and control the drilling to adjust to the observed conditions in real-time.

The one or more computer systems 720 can update the 3D maps of the subsurface formation as information from one exploration well is received and the computational operations 712 can adjust the location of the next exploration well based on the updated 3D maps. Similarly, the data received from production operations can be used by the computational operations 712 to control components of the production operations. For example, production well and pipeline data can be analyzed to predict slugging in pipelines leading to a refinery and the computational operations 712 can control machine operated valves upstream of the refinery to reduce the likelihood of plant disruptions that run the risk of taking the plant offline.

In some implementations of the computational operations 712, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 8 is a block diagram 800 illustrating an example of a computer system 800 used to provide computational functionalities associated with described algorithms, methods, functions, processes, flows, and procedures, according to an implementation of the present disclosure. The illustrated computer 802 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 802 can comprise a computing device that includes an input device, such as a keypad, keyboard, touch screen, another input device, or a combination of input devices that can accept user information, and an output device that conveys information associated with the operation of the computer 802, including digital data, visual, audio, another type of information, or a combination of types of information, on a graphical-type user interface (UI) (or GUI) or other UI.

The computer 802 can serve in a role in a computer system as a client, network component, a server, a database or another persistency, another role, or a combination of roles for performing the subject matter described in the present disclosure. The illustrated computer 802 is communicably coupled with a network 830. In some implementations, one or more components of the computer 802 can be configured to operate within an environment, including cloud-computing-based, local, global, another environment, or a combination of environments.

The computer 802 is an electronic computing device operable to receive, transmit, process, store, or manage data and information associated with the described subject matter. According to some implementations, the computer 802 can also include or be communicably coupled with a server, including an application server, e-mail server, web server, caching server, streaming data server, another server, or a combination of servers.

The computer 802 can receive requests over network 830 (for example, from a client software application executing on another computer 802) and respond to the received requests by processing the received requests using a software application or a combination of software applications. In addition, requests can also be sent to the computer 802 from internal users, external or third-parties, or other entities, individuals, systems, or computers.

Each of the components of the computer 802 can communicate using a system bus 803. In some implementations, any or all of the components of the computer 802, including hardware, software, or a combination of hardware and software, can interface over the system bus 803 using an application programming interface (API) 812, a service layer 813, or a combination of the API 812 and service layer 813. The API 812 can include specifications for routines, data structures, and object classes. The API 812 can be either computer-language independent or dependent and refer to a complete interface, a single function, or even a set of APIs. The service layer 813 provides software services to the computer 802 or other components (whether illustrated or not) that are communicably coupled to the computer 802. The functionality of the computer 802 can be accessible for all service consumers using this service layer. Software services, such as those provided by the service layer 813, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 802, alternative implementations can illustrate the API 812 or the service layer 813 as stand-alone components in relation to other components of the computer 802 or other components (whether illustrated or not) that are communicably coupled to the computer 802. Moreover, any or all parts of the API 812 or the service layer 813 can be implemented as a child or a sub-module of another software module, enterprise application, or hardware module without departing from the scope of the present disclosure.

The computer 802 includes an interface 804. Although illustrated as a single interface 804 in FIG. 8, two or more interfaces 804 can be used according to particular needs, desires, or particular implementations of the computer 802. The interface 804 is used by the computer 802 for communicating with another computing system (whether illustrated or not) that is communicatively linked to the network 830 in a distributed environment. Generally, the interface 804 is operable to communicate with the network 830 and comprises logic encoded in software, hardware, or a combination of software and hardware. More specifically, the interface 804 can comprise software supporting one or more communication protocols associated with communications such that the network 830 or interface's hardware is operable to communicate physical signals within and outside of the illustrated computer 802.

The computer 802 includes a processor 805. Although illustrated as a single processor 805 in FIG. 8, two or more processors can be used according to particular needs, desires, or particular implementations of the computer 802. Generally, the processor 805 executes instructions and manipulates data to perform the operations of the computer 802 and any algorithms, methods, functions, processes, flows, and procedures as described in the present disclosure.

The computer 802 also includes a database 806 that can hold data for the computer 802, another component communicatively linked to the network 830 (whether illustrated or not), or a combination of the computer 802 and another component. For example, database 806 can be an in-memory, conventional, or another type of database storing data consistent with the present disclosure. In some implementations, database 806 can be a combination of two or more different database types (for example, a hybrid in-memory and conventional database) according to particular needs, desires, or particular implementations of the computer 802 and the described functionality. Although illustrated as a single database 806 in FIG. 8, two or more databases of similar or differing types can be used according to particular needs, desires, or particular implementations of the computer 802 and the described functionality. While database 806 is illustrated as an integral component of the computer 802, in alternative implementations, database 806 can be external to the computer 802. As illustrated, the database 806 holds data 816 including, for example, data encoding the seismic data traced acquired from receivers placed at a geophysical exploration site, as explained in more detail in association with FIGS. 1A-1B, 2A-2B, 3A-3C, and 5A-5D.

The computer 802 also includes a memory 807 that can hold data for the computer 802, another component or components communicatively linked to the network 830 (whether illustrated or not), or a combination of the computer 802 and another component. Memory 807 can store any data consistent with the present disclosure. In some implementations, memory 807 can be a combination of two or more different types of memory (for example, a combination of semiconductor and magnetic storage) according to particular needs, desires, or particular implementations of the computer 802 and the described functionality. Although illustrated as a single memory 807 in FIG. 8, two or more memories 807 or similar or differing types can be used according to particular needs, desires, or particular implementations of the computer 802 and the described functionality. While memory 807 is illustrated as an integral component of the computer 802, in alternative implementations, memory 807 can be external to the computer 802.

The application 808 is an algorithmic software engine providing functionality according to particular needs, desires, or particular implementations of the computer 802, particularly with respect to functionality described in the present disclosure. For example, application 808 can serve as one or more components, modules, or applications. Further, although illustrated as a single application 808, the application 808 can be implemented as multiple applications 808 on the computer 802. In addition, although illustrated as integral to the computer 802, in alternative implementations, the application 808 can be external to the computer 802.

The computer 802 can also include a power supply 814. The power supply 814 can include a rechargeable or non-rechargeable battery that can be configured to be either user- or non-user-replaceable. In some implementations, the power supply 814 can include power-conversion or management circuits (including recharging, standby, or another power management functionality). In some implementations, the power-supply 814 can include a power plug to allow the computer 802 to be plugged into a wall socket or another power source to, for example, power the computer 802 or recharge a rechargeable battery.

There can be any number of computers 802 associated with, or external to, a computer system containing computer 802, each computer 802 communicating over network 830. Further, the term “client,” “user,” or other appropriate terminology can be used interchangeably, as appropriate, without departing from the scope of the present disclosure. Moreover, the present disclosure contemplates that many users can use one computer 802, or that one user can use multiple computers 802.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/−R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method comprising:
accessing wireline data and vertical seismic profiling (VSP) data, both encoding measurements taken from boreholes at a geo-exploration site;
correlating velocity data log from the wireline data with velocity data from the VSP data to calibrate the velocity data log;
responsive to results of said correlating meeting a pre-determined threshold, determining, based on, at least in part, the calibrated velocity data log, a range of incidence angles for acquiring seismic traces that reach a formation depth at the geo-exploration site using pairs of acoustic emitter and acoustic receiver placed at a surface of the geo-exploration site;
subsequently determining a range of offsets between the acoustic emitter and the acoustic receiver of each pair so that the acoustic receiver can acquire seismic traces that reach the formation depth at the geo-exploration site; and
comparing the range of angles and the range of offsets with acquisition parameters of a planned seismic survey to determine whether the planned seismic survey can sufficiently map the geo-exploration site.

2. The computer-implemented method of claim 1, further comprising:
generating an alert that one or more of the acquisition parameters can cause the planned seismic survey to miss the formation depth at the geo-exploration site; and
causing the acquisition parameters to be modified so that the planned seismic survey can sufficiently map the geo-exploration site.

3. The computer-implemented method of claim 1, further comprising:
driving a rock physics model that operates on at least portions of the wireline data including the calibrated velocity data log to create synthetic gathers, wherein the rock physics model comprises a fluid substitution model instantiated at least twice to simulate a first instance of a first fluid condition at the geo-exploration site and a second instance for a second fluid condition at the geo-exploration site, and wherein the synthetic gathers include simulated seismic traces respectively for the first instance and the second instance.

4. The computer-implemented method of claim 3, wherein the range of incidence angles range from a minimum incidence angle to a critical angle.

5. The computer-implemented method of claim 4, further comprising:
generating, using an amplitude versus offset (AVO) model, responses to the synthetic gathers from the first instance and the second instance being launched from a surface of the geo-exploration site at various incidence angles; and
determining the minimum incidence angle above which variations between respective responses are observed.

6. The computer-implemented method of claim 4, further comprising:
generating, using an amplitude versus offset (AVO) model, responses to the synthetic gathers created in-situ from the wireline data at various incidence angles; and
determining a critical incidence angle beyond which the modeled response is fully reflected.

7. The computer-implemented method of claim 4, further comprising:
using a 1D ray tracing technique when determining the range of offsets.

8. The computer-implemented method of claim 7, wherein the 1D ray tracing technique is performed within the range of angles and under the critical angle.

9. The computer-implemented method of claim 1, wherein the velocity data log comprises compressional velocity (Vp) data, and wherein the velocity data from the VSP data comprises checkshot velocity data.

10. The computer-implemented method of claim 9, wherein when the velocity data log is calibrated, the Vp data is adjusted at depth points where the Vp data differs from the checkshot velocity data.

11. A computer system comprising one or more hardware computer processors configured to perform operations of:
accessing wireline data and vertical seismic profiling (VSP) data, both encoding measurements taken from boreholes at a geo-exploration site;
correlating velocity data log from the wireline data with velocity data from the VSP data to calibrate the velocity data log;
responsive to results of said correlating meeting a pre-determined threshold, determining, based on, at least in part, the calibrated velocity data log, a range of incidence angles for acquiring seismic traces that reach a formation depth at the geo-exploration site using pairs of acoustic emitter and acoustic receiver placed at a surface of the geo-exploration site;
subsequently determining a range of offsets between the acoustic emitter and the acoustic receiver of each pair so that the acoustic receiver can acquire seismic traces that reach the formation depth at the geo-exploration site; and
comparing the range of angles and the range of offsets with acquisition parameters of a planned seismic survey to determine whether the planned seismic survey can sufficiently map the geo-exploration site as deep as the formation depth.

12. The computer system of claim 11, wherein the operations further comprise:
generating an alert that one of more of the acquisition parameters can cause the planned seismic survey to miss the formation depth at the geo-exploration site; and
causing the acquisition parameters to be modified so that the planned seismic survey can sufficiently map the geo-exploration site.

13. The computer system of claim 11, wherein the operations further comprise:
driving a rock physics model that operates on at least portions of the wireline data including the calibrated velocity data log to create synthetic gathers, wherein the rock physics model comprises a fluid substitution model instantiated at least twice to simulate a first instance of a first fluid condition at the geo-exploration site and a second instance for a second fluid condition at the geo-exploration site, and wherein the synthetic gathers include simulated seismic traces respectively for the first instance and the second instance.

14. The computer system of claim 13, wherein the range of incidence angles range from a minimum incidence angle to a critical angle.

15. The computer system of claim 14, wherein the operations further comprise:
generating, using an amplitude versus offset (AVO) model, responses to the synthetic gathers from the first instance and the second instance being launched from a surface of the geo-exploration site at various incidence angles; and
determining the minimum incidence angle above which variations between respective responses are observed.

16. The computer system of claim 14, wherein the operations further comprise:
generating, using an amplitude versus offset (AVO) model, responses to the synthetic gathers created in-situ from the wireline data at various incidence angles; and
determining a critical incidence angle beyond which the modeled response is fully reflected.

17. The computer system of claim 14, wherein the operations further comprise:
using a 1D ray tracing technique when determining the range of offsets.

18. The computer system of claim 17, wherein the 1D ray tracing technique is applied within the range of angles and under the critical angle.

19. The computer system of claim 11, wherein the velocity data log comprises compressional velocity (Vp) data, and wherein the velocity data from the VSP data comprises checkshot velocity data.

20. The computer system of claim 19, wherein when the velocity data log is calibrated, the Vp data is adjusted at depth points where the Vp data differs from the checkshot velocity data.
